(19) United States
(12) Patent Application Publication
(10) Pub. No.: US 2008/0197238 A1
(43) Pub. Date: Aug. 21, 2008

(54) PHOTONIC LASER-BASED PROPULSION HAVING AN ACTIVE INTRACAVITY THRUST AMPLIFICATION SYSTEM

(76) Inventor: Young Kun Bae, Tustin, CA (US)

Correspondence Address: JAFARI LAW GROUP, P.C., 801 N. PARKCENTER DRIVE, SUITE 220, SANTA ANA, CA, 92705, US

(21) Appl. No.: 11/943,480

(22) Filed: Nov. 20, 2007

Related U.S. Application Data
(60) Provisional application No. 60/901,458, filed on Feb. 15, 2007.

(51) Int. Cl. H01S 3/08

(52) U.S. Cl. 244/171.1; 372/107

(57) ABSTRACT

The invention is a system and method for propelling and slowing down spacecraft and other space systems and objects using the thrust generated from the direct laser photon momentum transfer between two platforms to and from unprecedented high speeds approaching the speed of light. The thrust from the direct laser photon momentum is amplified in an intracavity arrangement, in which laser photons bounce between two high reflectance mirrors separately located in two platforms. The laser gain medium is typically located between two mirrors, and amplifies the intracavity photon power, thus creating amplified thrust. This intracavity medium location arrangement offers two critical advantages: 1) the ability to maintain the intracavity photon power constant when the distance between the mirrors rapidly changes; and 2) the ability to overcome the power loss mechanisms, such as scattering and absorption.

Furthermore, the current invention can be used for controlling the position and attitude of multiple spacecraft or spacecrafts in high precision formation flying or fractionated spacecraft architecture. This is advantageous over other propulsion concepts, such as chemical propulsion and laser beamed energy plasma or ablation propulsion, because the invention provides the highest specific impulse and dose not require any propellant, thus, significantly increases the payload fraction (payload weight/the total rocket weight), significantly decreases the payload launching cost, and is able to propel the spacecraft to velocities approaching the speed of light.

### PRIORITY NOTICE

The present application claims priority, under 35 USC § 199(e) and under 35 USC §120, to the U.S. Provisional Patent with Application Ser. No. 60/901,458 filed on Feb. 15, 2007, the disclosure of which is incorporated herein by reference in its entirety.

### COPYRIGHT & TRADEMARK NOTICE

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### TECHNICAL FIELD OF THE INVENTION

The present invention relates in general to photonic laser-based propulsion utilizing an active intracavity thrust amplification system, and in particular, to a system and method for propelling an object, for example a satellite or a spacecraft, using the thrust from the direct laser photon momentum transfer generated between two or more platforms to be used for wide ranges of applications, including achieving high velocities approaching the speed of light, docking, orbiting, de-orbiting, and precision flight formation control.

### BACKGROUND OF THE INVENTION

Recent developments in micro-satellite and nano-satellite technology have generated highly capable space platforms with sophisticated sensors and processing equipment. The advent of planetary and asteroid exploration has also sprung new developments in both robotic and manned missions into outer space. As technology that was once unavailable becomes accessible, new innovations and developments are integrated to solve problems of inefficiency and to reduce the extravagant costs associated with such off world endeavors.

Traditionally, we have been sending satellites and other vessels into space by launching rockets. This method requires monolithic amounts of fuel and thus become impractical for planetary and asteroid exploration for example, and their launching cost remains astronomical. Another obstacle presented by using rocket fuel is the speeds rocket propelled vessels can attain. Since the distances involved in space are so great, sending robotic or manned missions into space become problematic when missions take months or even years before an object or vessel may reach their destination.

The problem is the type of propellants that have been developed thus far. For example, with existing propulsion concepts, a vessel cannot begin to approach high velocities that draw near the speed of light. Conceptually, a modern vessel that begins to approach such high speeds will experience an exponentially increasing fuel mass, thus the concept quickly becomes impractical.

Laser propulsion has been an alternative that scientists and engineers have been developing in recent years but its applications have been very limited. However, as high-power and high-efficiency laser technology and optics technology continue to rapidly develop, the technical feasibility of laser propulsion has become more realistic.

One laser propulsion approach is the laser ablation propulsion that uses the mechanism of pulsed laser ablation with high power pulsed lasers. This approach suffers from several technological challenges including: (1) inefficient energy-to-momentum coupling between the laser power and propellants; (2) high power pulsed laser systems and associated optical systems are highly costly to construct, operate, and maintain; (3) extremely difficult laser focusing and beam shaping on rocket thrusters which requires highly complex and costly, yet to be developed, ultrahigh high power optics-including adaptive optics; and (4) many other technical difficulties in coupling high power pulsed laser beam energy and targets, for example such as thermal blooming.

Another approach to laser propulsion is to create a laser sustained plasma (LSP) with temperatures over 10,000 K in the flowing propellant, (e.g. argon), using pulsed or CW lasers. The plasma is localized near the focal point of a laser beam, and laser energy is absorbed through the electron inverse bremsstralung process. As the propellant gas flows through and around the stationary plasma, high bulk temperatures are sustained which can be in excess of 10,000 K in gases such as argon with power absorption efficiencies as high as 86%. Although the coupling of laser energy to the plasma has been found to be quite high, the overall propulsion efficiency is not adequate due to plasma radiation energy loss, and dissociative frozen flow losses that occur when utilizing molecular propellants such as hydrogen.

Another approach to energy addition that does not utilize plasma, is molecular absorption of radiation in the supersonic regime employing large molecules such as SF₆. This approach suffers from the technical challenges in highly complex energy coupling of supersonic propellant flow and in balancing the required low propellant exhaust temperature to avoid molecular dissociation. Because this approach requires high laser power density on the target of a spacecraft, it suffers from some of the technical challenges of the pulsed laser propulsion.

So far, existing methods suffer from relatively low specific impulse and result in only a marginal increase of payload fraction over conventional chemical-based propulsion. Thus, the economic viability of laser propulsion remains questionable, especially as the cost of conventional chemical-based propulsion launch has become significantly lower.

Therefore, there is a need for a more practical approach to photonic propulsion which can overcome or minimize the above mentioned technical challenges of the existing laser and photonic propulsion concepts so that space exploration may become more economical, efficient, and highly reliable. It is to these ends that the present invention has been developed.

### SUMMARY OF THE INVENTION

To minimize the limitations in the prior art, and to minimize other limitations that will be apparent upon reading and understanding the present specification, the present invention describes a laser-based propulsion system having an active intracavity thrust amplification system.

The present invention focuses on a system and method which uses the amplified thrust from the direct laser photon momentum transfer generated between two platforms, to achieve high velocities approaching the speed of light.

A method for inter-platform photonic laser propulsion, in accordance with the present invention, comprises attaching a first mirror to a first platform and a second mirror to a second platform, attaching a laser to said first platform, and attaching a laser gain medium to a back of, in front of or around said first mirror on said first platform. The laser gain medium is positioned to amplify said laser, and said laser attached to said first platform is activated, wherein said laser is positioned so that a laser beam generated by said laser energizes said gain medium to form an intracavity laser beam between said first mirror and said second mirror, and wherein said intracavity laser beam reflects off of a front of said first mirror and a front of said second mirror a plurality of times to create a thrust force that propels said second platform.

A photonic laser propulsion system, in accordance with the present invention, comprises a first platform, a second platform, positioned opposite said first platform, and a laser pumping system attached to said first platform, wherein said laser pumping system is adapted to generate a laser beam. Furthermore, a first mirror, attached to said first platform, comprises a back side adapted to transmit said laser beam to form an intracavity laser beam, and a front side adapted to reflect said intracavity laser beam, and a second mirror, attached to said second platform, comprising a front side adapted to reflect said intracavity laser beam, wherein said intracavity laser beam reflects a plurality of times between said front side of said first mirror and said front side of said second mirror to generate an amplified photon thrust force.

It is an objective of the present invention to provide a photonic laser propulsion approach that is advantageous over other conventional propulsion concepts, such as chemical propulsion, laser propulsion, laser ablation propulsion, or electric propulsion, by yielding a higher specific impulse.

It is another objective of the present invention to provide a system and method for laser propulsion wherein a vessel carries a minimal amount of its own energy source to significantly increase the payload fraction (payload weight/ total vessel weight) and significantly decrease the payload launching cost.

It is yet another objective of the present invention to provide low cost delivery of parts and supplies for space platforms such as a space station or highly capable nano-satellites (mass˜1-10 kg) and pico-satellites (mass<1 kg).

It is yet another objective of the present invention to provide a propulsion system capable of launching payloads from terra base platforms, or other space-based platforms, to remote locations in outer space.

It is yet another objective of the present invention to provide precision adjustment of position and attitudes of spacecraft and satellites in formation flying.

It is yet another objective of the present invention to accelerate a spacecraft or payload to velocities approaching the speed of light.

It is yet another objective of the present invention to stop or decelerate a platform, for example a spacecraft or payload, from high velocities to low or zero velocities.

It is yet another objective of the present invention to accelerate or decelerate a platform, for example a spacecraft or payload, by utilizing multiple photonic laser propulsion platforms in a series configuration to attain higher efficiency and provide additional power.

It is yet another objective of the present invention to provide a method of supplying power to a platform or vessel utilizing a laser propulsion system and photovoltaic cells.

Finally, it is yet another objective of the present invention to provide a method of fine tuning and control of a platform's or vessel's velocity vector, orientation, and attitude, utilizing small on-board conventional thrusters, such as chemical, electric and laser-ablation thrusters, or utilizing a directed laser beam delivered from another platform.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates a photonic laser propulsion system for launching or accelerating a platform, for example a spacecraft or vessel, in accordance with one embodiment of the present invention.

FIG. 2 illustrates several embodiments of resonance cavities for amplifying an intracavity laser beam in accordance with practice of the present invention.

FIG. 3 illustrates a photonic propulsion system used for precision formation flying or fractionated spacecraft architecture, in accordance with practice of the present invention.

FIG. 4 illustrates a block diagram of a photonic laser propulsion system configured for converting laser power from an extracavity laser into an electrical power source for a second platform, for example a launched vessel.

FIG. 5 illustrates a launching configuration utilizing an amplified photonic beam, in accordance with one embodiment of the present invention.

FIG. 6(a) illustrates a transit configuration which comprises of two platforms and a vessel, in accordance with one embodiment of the present invention.

FIG. 6(b) illustrates a close up of view of a vessel utilizing conventional thrusters to disengage from a first platform and engage contact with an intracavity laser beam generated from a second platform, in accordance with practice of the present invention.

FIG. 6(c) illustrates a transit configuration which comprises of two platforms and a vessel, in accordance with another embodiment of the present invention.

FIG. 7 illustrates a docking configuration utilizing an amplified photonic beam, in accordance with one embodiment of the present invention.

FIG. 8(a) and FIG. 8(b) illustrate a method of accelerating or decelerating a vessel, respectively, by utilizing a series of photonic laser propulsion platforms configured to progressively project photonic lasers for propelling a vessel into higher speeds or slowing it down from higher velocities.

### DETAILED DESCRIPTION OF THE DRAWINGS

In the following discussion that addresses a number of embodiments and applications of the present invention, reference is made to the accompanying drawings that form a part hereof, in which is shown by way of illustration specific embodiments in which the invention may be practiced. It is to be understood that other embodiments may be utilized and changes may be made without departing from the scope of the present invention.

The ultimate specific impulse, according to the specific relativity theory, is the specific impulse of light, which can only be achieved by particles with zero rest mass, for example photons. Since photonic laser propulsion uses photons as fuel, for which the exhaust velocity is the speed of light, it can be predicted to be able to accelerate a vessel with a velocity approaching the speed of light without the problem of exponentially increasing the fuel mass.

The present invention is based on active resonant cavity technology in which a laser gain medium is within the optical cavity of a laser propulsion engine. This configuration does not suffer from such challenges of the aforementioned passive optical cavity photon propulsion due to the use of an active optical cavity with laser gain within the cavity formed between mirrors located in separate platforms.

In particular, photonic laser propulsion is tolerant to multi-frequency-multimode laser operation, thus it is insensitive to the changes in distance between the mirrors that create the optical cavity. Because the laser beam is formed in the optical cavity between a pair of platforms, there is no difficulty in injecting the laser beam into the cavity. This feature is particularly important in accelerating a platform such as a vessel because the distance between mirrors of the accelerating vessel and mother platform will change rapidly. Furthermore, this feature is also important in adjusting the distance and attitude between two platforms or vessels without altering the photon thrust.

In the present disclosure, a platform may be a craft, a vessel, a satellite, any object designed for operation or travel in space beyond the earth's atmosphere, or in orbit around the earth, or any other type of object capable of operating or traveling in outer space, whether manned or unmanned. Furthermore, a platform may also be a launching pad located either on land, in earth's orbit, or in outer space.

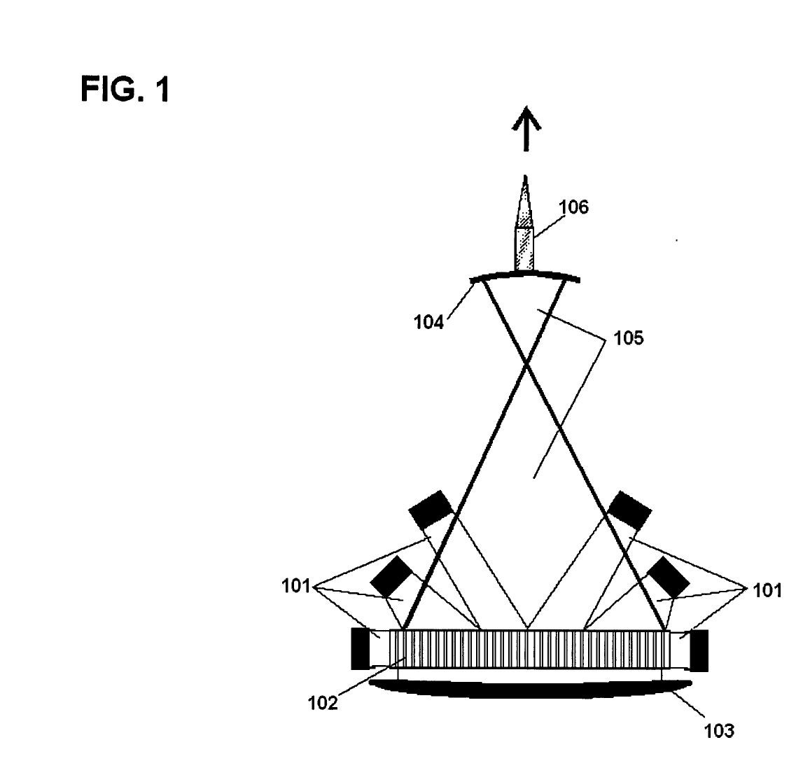

FIG. 1 illustrates a photonic laser propulsion system for launching or accelerating a platform, for example a spacecraft or vessel, in accordance with one embodiment of the present invention. The photonic laser propulsion system utilizes an optical cavity which is formed by two mirrors located separately in two platforms, for example a launching pad and a vessel.

The thrust of the photons is amplified by as much as 20,000 times by bouncing them between the two mirrors. For example, and without deviating from the scope of the present invention, a 10 megawatt (MW) laser thruster, suitable for launching or accelerating a vessel, may be capable of providing thrusts up to 1.34 kilonewtons (kN) with currently available technologies. This thrust efficiency well rivals that of the most efficient electric propulsion system.

FIG. 1 depicts the several components, and their interrelation, that make up one embodiment of a photonic laser propulsion system in accordance with the present invention. FIG. 1 shows pump sources 100, pump laser beams 101, a laser gain medium 102, first mirror 103, second mirror 104, intracavity laser beam 105, and vessel 106.

As laser 105 is amplified between first mirror 103 and second mirror 104, mirror 104 is repelled away from mirror 103, thus propelling vessel 106 towards a desired location. For example, and without limiting the scope of the present invention, pump sources 100 emit photon beams 101 towards laser gain medium 102. Pump laser beams 101 pump or energize laser gain medium 102, which increases the optical gain of intracavity laser beam 105. A majority of the intracavity laser beam 105 bounces off second mirror 104 back to and towards first mirror 103, and so on and so forth, amplifying laser beam 105. Laser beam 105's amplification creates a thrust force in the direction (depicted by the arrow) away from first mirror 103 as mirror 104 is repelled away from mirror 103.

Pump sources 100 can be electricity, a flash lamp, another laser, an electron beam, electricity, chemical transition engines, or any other appropriate pump source without departing from the scope of the present invention.

In an exemplary embodiment, pump sources 100 comprise laser diodes or flash lamps. Pump sources 100 may be operated in both continuous wave or pulsed fashion, and the precision timing for the duration of powering the continuous wave laser or the pulse length of a pulsed laser can be controlled by, for example, a precision digital clock (not shown).

In another embodiment, pump sources 100 are laser diodes operating in continuous wave fashion so as to prevent perturbations from repeated photon pulses.

Laser gain medium 102 can be positioned behind, around or in front of first mirror 103, and may be either attached to, or separated from, first mirror 103 without departing the scope of the present invention. Laser gain medium 102 may comprise a gas medium, a dye medium, a metal-vapor medium, a solid state medium, a semiconductor medium, or any other type of medium without departing from the scope of the present invention.

Alternatively, gain medium 102 may comprise Er:YAG, Nd:YLF, Nd:YCa₄O, Nd:Glass, Ti:sapphire, Tm:YAG, Yb:YAG, Ho:YAG, Ce:LiCAF, U:CaF₂, Sm:CaF₂, Nd:YVO₄ or any other solid state laser crystal without departing from the scope of the present invention. In an exemplary embodiment, laser gain medium 102 is a solid state laser crystal, for example Nd:YAG.

Gain medium 102 may comprise of variable thickness. In one embodiment, laser gain medium 102 is very thin to minimize absorption loss. In such embodiment, laser gain medium 102 is end or side pumped by pump sources 100 which further comprise one or more laser diodes or laser diode arrays. However, with a thin laser gain medium 102, thermal management of laser gain medium 102 may become a critical issue. A thin laser gain medium 102 may be attached to or grown on first mirror 103 and cooled in order to maintain a required temperature range for optimum performance by utilizing a conventional cooling system.

If pump sources 100 are strong lasers, the laser gain medium 102 may be left out of an embodiment without departing from the scope of the present invention. In this embodiment, the pump sources have to be combined to form a single or multiple coherent laser beam(s).

In calculating the thrust necessary to propel vessel 106, we let thrust, F_{T}, be the force produced by laser beam 105 on each mirror 103 and 104; this force repels second mirror 104 away from first mirror 103 which in turn propels vessel 106. Thus, F_{T} is given by the following formula:

$${F}_{T} = \frac{2 PRS}{c} , \qquad ( 1 )$$

where P is the is extracavity laser output power through mirror 104, c is the constant speed of light, 3×10⁸ m/s; R is the output coupler mirror reflectance (˜1); and S is the apparent power enhancement factor—the ratio of the intracavity laser power to the extracavity laser power, P.

S, is further given by the following formula where, again, R is the output coupler mirror reflectance (˜1):

$$S = \frac{1}{1 - R} , \qquad ( 2 )$$

Parameters which determine the maximum attainable intracavity laser power, thus photonic thrust, are: (1) the power saturation of gain medium 102; (2) the thermal management capacity of gain medium 102; and each mirrors,' 103 and 104, manufacturing consistency—for example the higher the level of reflectivity each mirror has the more amplification and thus more thrust will be possible. Thus, how far and how fast vessel 106 may travel will depend on the size of vessel 106, the power of laser pump sources 100, the power of laser beam 105, the type of medium utilized in gain medium 102, and other factors such as the size and reflectivity of mirrors 103 and 104.

Furthermore, first mirror 103 and second mirror 104 may be positioned and shaped in many different ways in order to induce a plurality of reflections of intracavity laser beam 105 and maximize laser thrust to vessel 106. First mirror 103 and second mirror 104 must be, however, positioned so that intracavity laser beam 105 ricochets between both mirrors multiple times. Because the laser photons are virtually trapped in the intracavity beam 105, the average laser power in the intracavity will be amplified.

In an exemplary embodiment, first mirror 103 and second mirror 104 are coated with a high-reflector layer to bring a reflection coefficient of each mirror very close to 1. For example, if a reflectance of first mirror 103 and second mirror 104 is 0.999, the power of the intracavity laser beam 105 can be 1,000 times larger than that of the extracavity laser beam. The higher the reflection coefficient of first mirror 103 and second mirror 104, the more powerful the laser thrust that propels vessel 106.

For estimating the theoretical limit maximum intracavity laser power and the corresponding thrust, the other parameters are neglected, and results of the maximum theoretical thrusts as a function of the reflectance of the mirrors can be calculated. For example, and without limiting the scope of the present invention, at an extracavity laser power level of 10 megawatts (MW), the maximum theoretical thrusts as a function of the reflectance of the mirrors may be summarized as in Table 1.0.

TABLE 1.0

| Maximum Operation | | Maximum | |
|---|---|---|---|
| Laser Power | | Theoretical | |
| (extracavity) | HR Mirror Reflectance | Thrust | |
| 10 MW | 0.90-0.99 (commonly used | 0.67-6.7 | N |
| | in laser cavities) | | |
| 10 MW | 0.999 (used in laser | 67 | N |
| | cavities) | | |
| 10 MW | 0.9999 (research grade) | 670 | N |
| 10 MW | 0.99995 (typically used | 1.34 | kN |
| | super mirror) | | |
| 10 MW | 0.999998 (with 1 ppm mirror | 22.3 | kN |
| | absorption) | | |

Since a photonic laser propulsion system in accordance with the present invention should be designed to maximize the intracavity power, it may be desirable for gain medium 102 to be very thin in order to minimize any absorption loss. For example, and without deviating from the scope of the present invention, gain medium 102 may be similar to gain mediums used in state of the art solid state disk lasers for intracavity second harmonic generation, except without the need for a frequency doubling crystal. Again, when using a thin gain medium, the thermal management of the gain medium becomes an important issue and a cooling system should be installed.

Several other factors other than the reflectivity and absorption loss of the mirrors should be considered, including thermal limitation and optical absorption and saturation of laser gain medium 102. Therefore, due to the limitation in laser gain medium 102 and other thermal effect, the total thrust presented in Table 1 should be considered as upper bounds.

The absolute technological boundary of the present system may be obtained with super mirrors used for cavity ring down spectroscopy (currently available in advanced research grade only) with a reflectance greater than 0.99995.

With new developments such as a thin film deposition technique, it is expected that in the near future, more reliable mirrors with higher reflectivity can be produced. The thrust obtainable with such super mirrors assuming 1 ppm absorption loss with a 10 MW laser is about 22.3 kN. Under such operational conditions, the laser power in the cavity exceeds TW (10¹² W).

Based on the currently available laser technology, by making gain medium 102 thin enough, a photonic laser propulsion engine with 0.999-0.9999 may be constructed. With the reflectivity of 0.9999, 10 MW photon thrusters are predicted to be able to deliver up to 670 N, which is large enough to launch small payloads at high speeds in space or into Earth's orbit from a ground launch site.

As previously stated, other parameters must be considered aside from reflectivity, such as the size of each mirror and the mass of the payload (e.g. vessel 106) that intracavity laser beam 105 may be propelling.

Typically, the mass of the launching system (i.e. gain medium 102, laser pump sources 100, and mirror 103) is much greater than the mass of the payload (i.e. mirror 104 and vessel 106). Calculating vessel 106's maximum velocity, Vₘₐₓ, is thus given by:

$${V}_{max} = \sqrt{\frac{2 {F}_{T} L}{M}} , \qquad ( 3 )$$

where L is the distance at which a payload may travel at max velocity, and M is the mass of the launched payload, for example, the weight of vessel 106 and mirror 104.

For example, if the scattering and absorption of the optical cavity is negligible, a 10 MW laser system, with 0.99995 reflectance mirrors, a payload of 1 kg (i.e. M=1 kg), and a distance capacity of 1,000 km (i.e. L=1,000 km), will yield a maximum velocity, Vₘₐₓ, of approximately 52 km/sec. The same system with 0.999998 reflectance mirrors will yield a maximum velocity, Vₘₐₓ, of approximately 217 km/sec.

Some other examples of maximum attainable velocities are given in Table 2. Table 2 also summarizes the time required to propel a platform or vessel:

TABLE 2

| R | F_{T} (kN) | L (km) | Vₘₐₓ (km/sec) | Time (sec) |
|---|---|---|---|---|
| 0.99995 | 1.35 | 1,000 | 52 | 38 |
| 0.999998 | 23.5 | 1,000 | 217 | 9.2 |
| | | 10,000 | 375 | 29 |
| | | 100,000 | 2,170 | 92 |
| | | 1,000,000 | 3,750 | 290 |

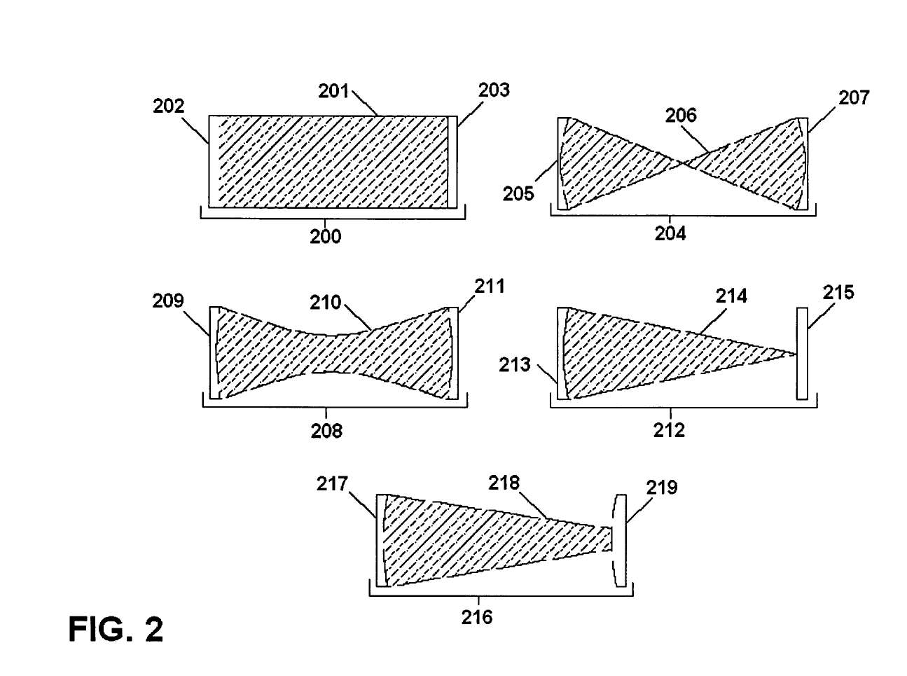

The maximum range of operation of the disclosed system depends mainly on the diameter of mirrors 103 and 104. The theoretical limit of the intracavity length or distance between mirrors in the optical cavity, between mirrors 103 and 104, is ˜L, and depending on the type or shape of the mirrors that form the cavity, the maximum range of operation, L, will vary. For example, and without limiting the scope of the present invention, for a confocal cavity resonator (see FIG. 2), L is given by:

$$L = \frac{{r}_{1} {r}_{2}}{λ} , \qquad ( 4 )$$

where r₁ and r₂ are the radii of the laser beam projected onto the mirrors, and λ is the wavelength of the laser. Thus, if we assume λ=10⁻⁶ m, L=1,000 km, and r₁=0.2 m (assuming r₁ is the radius of the mirror installed at the launching, for example first mirror 103) then, using formula (4), it may be calculated that the required minimum radius of the launching system mirror is 5 m. For L =1,000 km system, various numerical examples of the mirror radius requirements are summarized in Table 3.

TABLE 3

| | |
|---|---|
| | Required Launching |
| Launched System Mirror Radius | System Mirror Radius |

| | | | |
|---|---|---|---|
| 1 | m | 1 | m |
| 0.5 | m | 2 | m |
| 0.2 | m | 5 | m |
| 0.1 | m | 10 | m |

The fabrication of high quality super mirrors with radii in the order of 1 m is well within the currently available state-of-the-art mirror manufacturing technologies. The weight of these mirrors is also well within the payload capability of the currently used satellite systems. Several optional embodiments of resonant cavities, formed by intracavity mirrors such as first mirror 103 and second mirror 104, are illustrated in FIG. 2.

FIG. 2 is an illustration of different embodiments of intracavity mirrors or resonant cavities. Specifically, FIG. 2 depicts: flat mirror embodiment 200, concentric mirror embodiment 204, confocal mirror embodiment 208, hemispherical mirror embodiment 212, and concave-convex mirror embodiment 216. Each embodiment of resonant cavities, in accordance with the present invention, and their advantages, are discussed in turn.

Flat mirror embodiment 200 comprises of flat mirror 201, intracavity laser beam 202, and flat mirror 203. In flat mirror embodiment 200, flat mirror 201 and flat mirror 203 are both completely flat, reflecting intracavity 202 in a straight line. This embodiment has an advantage of reflecting a maximum amount of intracavity laser beam 202 at any distance. A slight angle deviation, however, could reflect intracavity laser beam 202 towards an undesired target, severely limiting the number of reflections of intracavity laser beam 202, and hence thrust power. Typically, flat mirror 201 and flat mirror 203 should face each other with an accuracy of one arcsecond.

Concentric mirror embodiment 204 comprises of concentric mirror 205, intracavity laser beam 206, and concentric mirror 207. In concentric mirror embodiment 204, concentric mirror 205 and concentric mirror 207 are curved to reflect intracavity laser beam 206 at an angle such that a portion of intracavity laser beam 206 that hits a section of concentric mirror 205 will be reflected towards an opposite section of concentric mirror 207. For example, a laser beam that reflects off of the very top of concentric mirror 205 would reflect towards the very bottom of concentric mirror 207. Typically, concentric mirror 205 and concentric mirror 207 are spherically curved, with a radius of curvature equal to twice an ideal distance between concentric mirror 205 and concentric mirror 207, but concentric mirror 205 and concentric mirror 207 can be shaped and focused parabolically without deviating from the scope of the present invention. A mirror that is focused as a paraboloid instead of a perfect sphere can focus intracavity laser beam 206 at a sharper focal point than spherical mirrors, which may have a spherical aberration defect.

Concentric mirror embodiment 204 also has the benefit of a self-aligning property, as the ricocheting photons will tend to push first concentric mirror 205 and second concentric mirror 207 into a position where both mirrors exactly face each other. Additionally, a first concentric mirror 205 and second concentric mirror 207 shaped to form a confocal resonator will have much less diffraction loss than if they were shaped as flat mirrors.

Confocal mirror embodiment 208 comprises confocal mirror 209, and intracavity laser beam 210, and confocal mirror 211. In confocal mirror embodiment 208, confocal mirror 209 and confocal mirror 211 are curved to reflect intracavity laser beam 210 at an angle such that a portion of intracavity laser beam 210 that hits a section of confocal mirror 209 will be reflected towards a center of confocal mirror 211, and vice-versa. Typically, confocal mirror 209 and confocal mirror 211 are spherically curved, with a radius of curvature equal an ideal distance between confocal mirror 209 and confocal mirror 211, but confocal mirror 209 and concentric mirror 211 can be shaped and focused parabolically without deviating from the scope of the present invention. A mirror that is focused as a paraboloid instead of a perfect sphere can focus intracavity laser beam 210 at a sharper focal point than spherical mirrors, which may have a spherical aberration defect.

Similar to concentric mirror embodiment 204, confocal resonator embodiment 208 also has the benefit of a self-aligning property. Confocal mirror 209 and confocal mirror 211 are typically only required to face each other with an accuracy of a quarter of a degree—two orders of magnitude less stringent than with flat mirror embodiment 200. Confocal resonator embodiment 208 also has even less diffraction than concentric mirror embodiment 204.

For both concentric resonator embodiment 204 and confocal resonator embodiment 208, distance between the mirrors involved is a factor. A concentric resonator embodiment 204 takes maximal effect when the distance between concentric mirror 205 and concentric mirror 207 is equal to twice the radius of curvature when curved spherically, or twice the focal length when curved parabolically. Likewise, a confocal resonator embodiment 208 takes maximum effect when the distance between confocal mirror 209 and confocal mirror 211 is equal to the radius of curvature when curved spherically, or the focal length when curved parabolically.

Intracavity mirrors need not be identically curved. For example, hemispherical mirror embodiment 212 comprises of one hemispherical mirror 213, intracavity laser beam 214, and one flat mirror 215. In an exemplary hemispherical mirror embodiment 212, hemispherical mirror 213 is curved either confocally or parabolically to focus intracavity laser beam 214 a certain ideal distance. Since hemispherical mirror 213 can focus intracavity laser beam 214 to a point, flat mirror 215 can be much smaller than hemispherical mirror 213. A smaller mirror can be useful for a space system with stringent weight requirements, or a hub satellite which must reflect a plurality of intracavity laser beams. Additionally, if flat mirror 215 is smaller, a laser beam positioned behind flat mirror 215 may be aimed directly at hemispherical mirror 213 wherein only a small percentage of the laser beam travels through flat mirror 215, which decreases possible absorption by the back of flat mirror 215.

Concave-convex mirror embodiment 216 comprises concave mirror 217, intracavity laser beam 218, and convex mirror 219. In concave-convex mirror embodiment 216, concave mirror 217 is curved confocally or parabolically to focus intracavity laser beam 218 towards a convex mirror 219 up to a certain ideal distance. Much like flat mirror 215, convex mirror 219 may also be much smaller than the opposing mirror, in this example concave mirror 217. Concave-convex mirror embodiment 216 has the benefit of a self-aligning property, in addition to having the benefit of a smaller mirror, which may be useful for outer space missions with stringent weight requirements, for example a hub satellite which must reflect a plurality of intracavity laser beams.

In typical propulsion architecture, the mirror of the launching platform may be much larger than that of the launched platform. However, there are many other embodiments of intracavity lasers that may be used without departing from the scope of the present invention. In all types of resonant cavities, the size of the mirrors can be different in size and shape, and in some embodiments, the curvatures of the mirrors may be altered to allow for a more versatile resonant cavity.

In an exemplary embodiment, the resonant cavity utilizes adaptive optics technology, which can literally change the mirrors into any shape. This technology has been well developed for large earth-bound telescopes (as well as laser weapons) to cope with the atmosphere disturbance effect. The same technology can be used in such exemplary embodiment for calibrating and positioning the mirrors in a resonant cavity, for example, to change the curvature of the mirrors from a flat mirror configuration, to a concentric mirror configuration, to a confocal mirror configuration, to a hemispherical mirror configuration, or to a concave-convex mirror configuration. Such technology may be applied to, for example, counter the atmospheric disturbance effect; the surface shape of the mirrors can be modulated/tailored or changed to direct the disturbed rays in the intracavity laser beam.

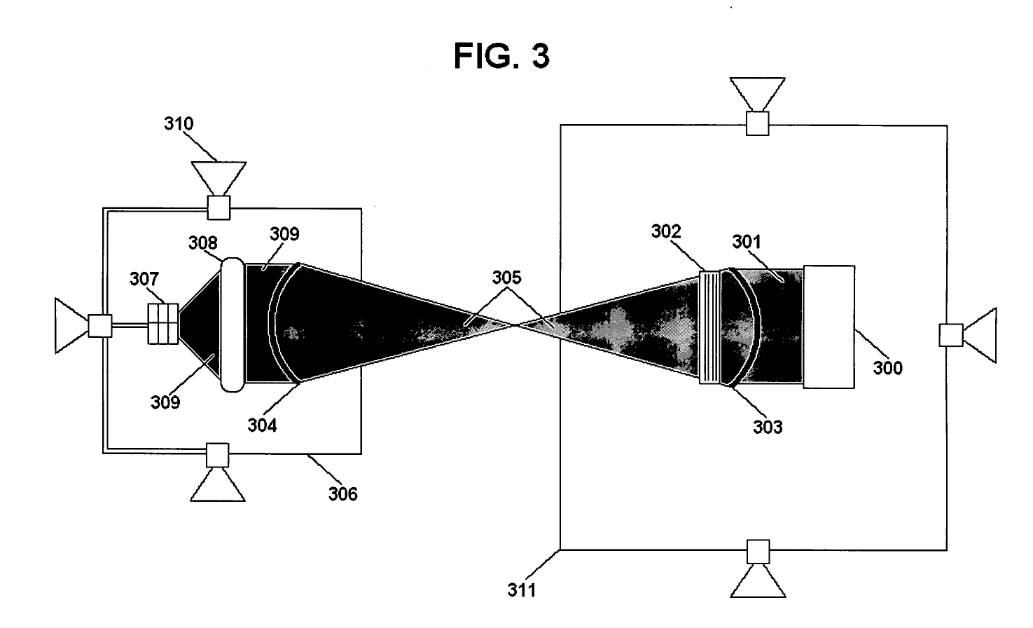

FIG. 3 depicts another embodiment of the present invention, which comprises of pump source 300, pump laser beam 301, laser gain medium 302, first mirror 303, second mirror 304, and intracavity laser beam 305.

Typically, pump source 300, first mirror 303 and gain medium 302 are located in launching platform 311. This configuration is desirable because it is more efficient and economically feasible to provide power to power source 300 if power source 300 is in a stable location, for example stationed at a particular point outside Earth's atmosphere, or on land on Earth's surface. This way, power may be supplied to pump source 300 continuously, allowing platform 306, which may be a vessel or satellite for example, to travel great distances without having to carry its own primary power source or propellant.

In the illustrated embodiment, launching platform 311 further comprises of conventional thrusters 310. Conventional thrusters 310 may further comprise, but are not limited to, cold gas thrusters, warm gas thrusters, electro thermal thrusters, Hall thrusters, pulsed plasma thrusters, laser ablation thrusters, and microwave electric thrusters; all arrangements that may provide more flexible spacecraft configurations in formation flying or fractionated spacecraft architecture.

Conventional thrusters 310 may be useful when launching platform 311 is stationed outside Earth's atmosphere in order to launch platform 306 to some remote destination. By utilizing conventional thrusters 310, launching platform 311 may perform any required adjustments both to keep laser beam 305 aligned correctly with platform 306 and second mirror 304, and to keep launching platform 311 from being repelled away from its stationed location by the thrust force from the amplification of intracavity laser beam 305.

Platform 306, which comprises of the remaining components of the photonic laser propulsion system, also has conventional thrusters 310 installed so that platform 306 too can perform constant adjustments throughout its flight. Platform 306 further comprises second mirror 304, a lens 308, and photovoltaic cells 307.

Similar to the embodiment disclosed in reference to FIG. 1, the illustrated embodiment works in the same fashion. Pump source 300 emits photon beam 301 towards a laser gain medium 302. Pump laser beam 301 pumps or energizes laser gain medium 302 which increases or amplifies the optical gain of the intracavity laser beam 305. The majority of intracavity laser beam 305 bounces off second mirror 304 and back towards first mirror 303, and so on and so forth, continuously bouncing off photons from one mirror to the other, amplifying laser beam 305. This amplification creates a thrust force which repels platform 306 away from launching platform 311, thus propelling platform 306 to a remote destination.

Due to a transparency factor in mirror 304, a percentage of intracavity laser beam 305 will be transmitted through the opposite side of second mirror 304 inevitably creating an extracavity laser beam 309. It is therefore desirable to be able to utilize any energy that may be available via extracavity beam 309 and implement that energy into the functionality of platform 306, thus making a more efficient use of the available resources. For example, and without limiting the scope of the present invention, extracavity laser beam 309 may be focused through lens 308 onto a receiving input area of device 307.

In one embodiment, device 307 is a laser power meter which provides diagnostic information or parameters relating to intracavity laser beam 305.

In another embodiment, device 307 comprises of photovoltaic cells which may be used to convert laser power into an electrical power source to provide energy for operating systems, for example, to calibrate conventional thrusters 310.

In yet another embodiment, device 307 is a laser powered heat exchanger for heating a propellant for conventional thruster 310.

Furthermore, in yet another embodiment, both photovoltaic cells and a meter device may be installed to utilize the laser power from extracavity laser beam 309; such embodiment is discussed in turn.

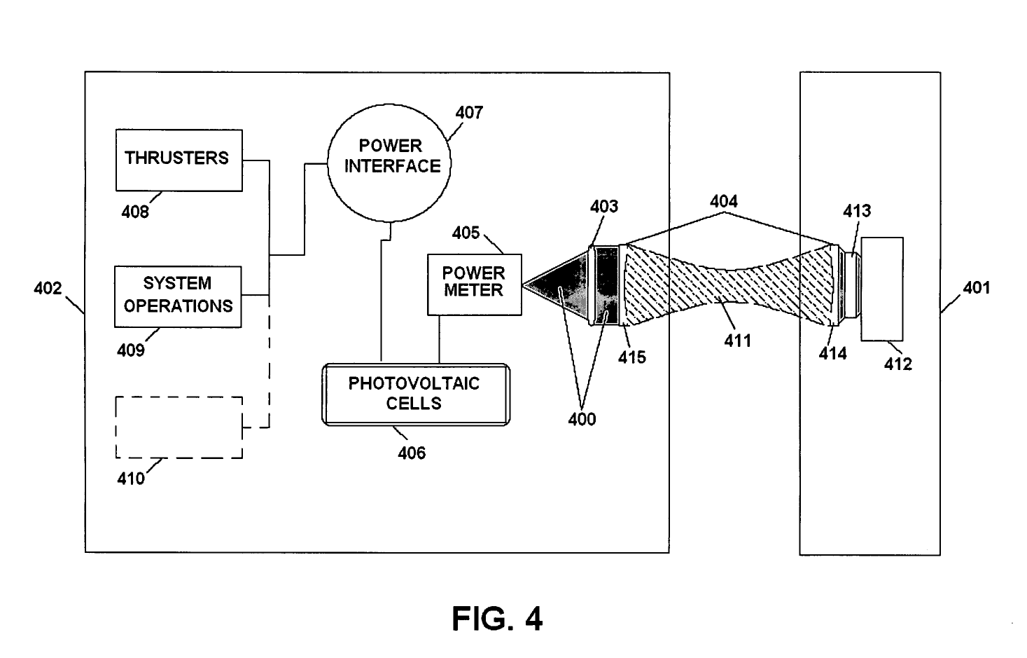

FIG. 4 illustrates a block diagram of a photonic laser propulsion system configured for converting laser power from an extracavity laser into an electrical power source to power equipment and thrusters in a second platform, for example a launched vessel in mid flight to a remote destination.

FIG. 4 depicts a photonic laser propulsion system in accordance with the present invention, similar to the system disclosed above in reference to FIG. 3. The illustration depicts launching platform 401 and vessel 402 equipped with a confocal resonator cavity 404, formed by confocal mirrors 414 and 415. A power source (not shown) located at the launch site, provides pump source 412 with power to energize gain medium 413 to produce intracavity laser beam 411, which will be amplified to yield a thrust force, propelling vessel 402 to its destination. Vessel 402 may comprise of several types of equipment, often retrofitted onto vessels such as micro-satellites and nano-satellites whether to aid the vessel in its flight or for research purposes during its mission. It may therefore be desirable to configure vessel 402 to convert power generated from its photonic laser propulsion system into available electric power that may be utilized to aid vessel 402's flight or power any retrofitted components.

In the illustrated embodiment, extracavity laser beam 400 is focused through lens 403 onto photovoltaic cells 406. Photovoltaic cells 407 comprise of a known technology in which light is converted into electrical power—these have been configured to generate power from a laser beam and convert that power into electricity. This method for generating power may be desirable, for example, to generate electrical power to fuel vessel 402's conventional thrusters 408 via extracavity laser beam 400 rather than carry additional batteries or devices in order to fuel said thrusters 408. Furthermore, any electrical power converted by photovoltaic cells 406 may be utilized for any other auxiliary operating system installed on vessel 402.

By focusing extracavity laser beam 400 through lens 403 towards a receiving input area, properties of extracavity laser beam 400 may be measured utilizing a laser power meter 405. These readings are desirable in order to learn information regarding the status of intracavity laser beam 411, which may be important to maintain intracavity laser beam 411 working at maximum capacity. For example, a user of such photonic laser propulsion system would want to extrapolate how much thrust is produced by intracavity laser beam 411 by measuring the power of extracavity laser beam 400.

As mentioned above, photovoltaic cells 406 may be configured to power several systems within vessel 402. However, in yet another embodiment, a focused extracavity laser beam 400 may be used for ablating materials of a target to provide extra thrust.

In the illustrated embodiment, photovoltaic cells 406 are connected to a power interface 407 to which several components may be connected to and be provided with an electrical power source. Vessel 402 has thrusters 408, and operations system 409 powered by extracavity laser beam 400. Additionally, and depending on the parameters and capabilities of intracavity laser beam 411, device 410 may comprise of one or more additional systems that can aid vessel 402 in a particular mission.

In one embodiment other device 410 may comprise a tether system that may be operated utilizing said electrical power. For example, and without limiting the scope of the present invention, in Photon Tether Formation Flights where a tether reel and electromagnetic damper may be utilized along with a clamp to allow for low-noise adjustments of several nano-satellites or micro-satellites, photovoltaic cells 406 may convert some or all of the necessary electrical power necessary to engage necessary components of the tether system.

In another embodiment, device 410 may comprise of a scientific payload that may need to be powered to perform some task at some point during vessel 402′ s flight or upon reaching its destination. In still another embodiment, device 410 may comprise an interferometric system; photovoltaic cells 406 may generate electrical power to fuel its components.

Instead of, or in addition to, providing each of the aforementioned systems and devices with a separate power supply, photovoltaic cells 406 can harness the energy supplied by extracavity laser beam 400 to provide such systems (i.e. other device 410) with the necessary electrical power source.

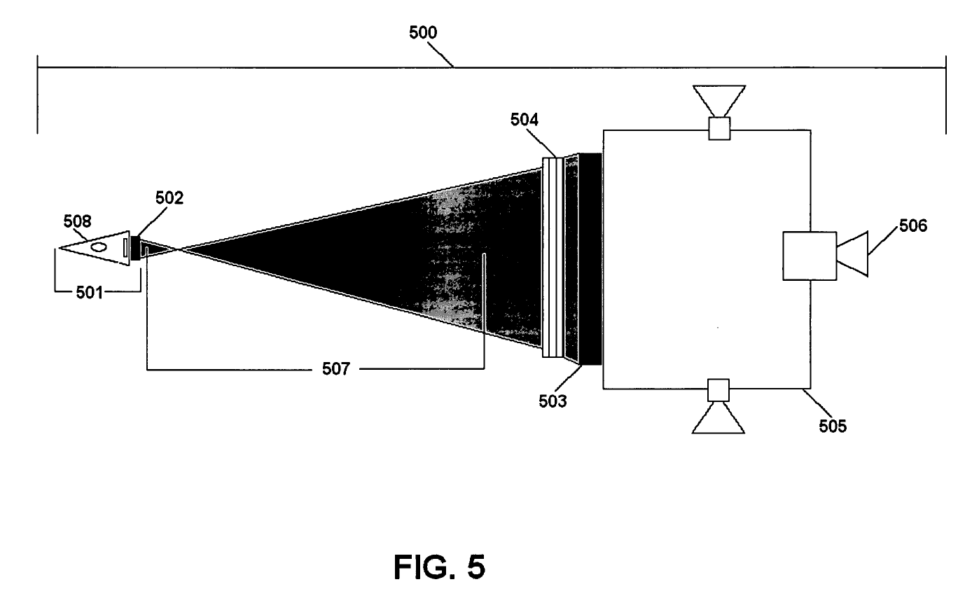

For example, and without limiting the scope of the present invention, device 410 may comprise a back up generator or battery that can be charged while intracavity laser beam 411 is engaged—ready for use upon disengagement of intracavity laser beam 411, for example during vessel 402's transition from a first launching platform to a second landing platform at a remote destination. During a period of time when vessel 402 is not being propelled by the photonic laser propulsion system, it may be desirable to have back-up power supply, or additional power supply, to provide necessary systems such as thrusters that will help guide vessel 402 to its destination and dock at a second platform. Such flight plan, including a launching configuration, a transitional configuration, and a docking configuration, is explained as way of illustration in some detail below, with reference to FIG. 5-FIG. 7, respectively.

FIG. 5 illustrates a launching configuration utilizing an amplified photonic beam, in accordance with one embodiment of the present invention.

Launching configuration 500 comprises of a first platform 505, which has been retrofitted with a first mirror 503 and a gain medium 504, and second platform 501, which is retrofitted with second mirror 502. Additionally, first platform 505 further comprises a pump source and energy source (not shown) to energize gain media 504. Second platform 501 includes a second mirror 502 to create a resonant cavity necessary to amplify intracavity laser beam 507.

As illustrated, first platform 505 is stationed in space in one of the lower Earth orbits, or other orbits, however, first platform 505 may be a land-based launching platform, a space station, a large satellite, a space shuttle, an aircraft, or any other type of platform capable of launching a second platform in accordance with the present invention, without limiting the scope of the present invention.

In some cases, first platform 505 is stationed at some location in space, thus, it is desirable for first platform 505 to comprise some type of conventional thrusters to make adjustments and stabilize first platform 505 during the launching of second platform 501. These adjustments may be necessary to prevent a backwards thrust from repelling first platform away from its stationed position, or to stabilize intracavity laser beam 507 during operation. Conventional thrusters 506 may be cold gas thrusters, warm gas thrusters, electro thermal thrusters, Hall thrusters, pulsed plasma thrusters, laser ablation thrusters, microwave electric thrusters, or any other type of thruster, without deviating from the scope of the present invention.

Do to the natural forces generated by the propulsion method, each platform may naturally repel away from each other. Thus, in other cases, first platform 505 may be deliberately repelled in an opposite direction from second platform 501 for example, to lower its first platform 505's orbit or to de-orbit first platform 505, or in other applications such as formation flights amongst a group of satellites.

As mentioned above, second platform 501 may be a craft, a vessel, a satellite, an other object designed for operation or travel in space beyond the earth's atmosphere, or in orbit around the earth, or any other type of object capable of operating or traveling in outer space, whether manned or unmanned, without deviating from the scope of the present invention.

In the illustrated embodiment, second platform 501 comprises of vessel 508 which is connected to second mirror 502. Upon activation of pump source 503, intracavity laser beam 507 is amplified and the thrust force created from this amplification launches second platform 501 to a remote destination, for example a higher Earth orbit. Launching configuration 500 is therefore desirable in particular with applications that comprise sending a device or vessel, for example a nano-satellite or micro-satellite, from a lower orbit to a higher orbit.

For example, and without limiting the scope of the present invention, instead of spending monolithic amounts of fuel and valuable resources to send vessel 508 into a higher orbit, such as the Geosynchronous Earth Orbit (GEO), launching configuration 500 may be deployed at a lower orbit, such as the Low Earth Orbit (LEO), in order to launch second platform 501; presently existing technology can easily launch a conventional rocket containing launching configuration 500, deploy said launching configuration 500, and activate pump source 503 to propel second platform 501 to its intended destination.

Alternatively, in other embodiments of launching configuration 500, first platform 505 may be positioned on any terra-based platform, airborne platform, or space-based platform. For example, and without limiting the scope of the present invention, first platform 505 may be positioned on Earth's surface, on the moon's surface, the surfaces of any other planets or their moons, or surfaces of asteroids, on an aircraft, a space station, or other stationary platform (without the need for conventional thrusters 506) to launch second platform 501 directly to its destination- naturally the laser power parameters will differ from one embodiment to another, depending on the requirements of a particular application.

In another embodiment, (not illustrated in FIG. 5), second platform 501 may have additional equipment to aid the photonic laser propulsion flight. For example, and without deviating from the scope of the present invention, second platform 501 may further comprise of small thrusters, a photovoltaic system, and a laser beam directing system that can be used for precise controlling of its thrust vector. Furthermore, second platform 501 may have numerous gyroscopic devices or reaction wheels to stabilize its movement; for instance, in some cases, second platform 501 may be spun to stabilize a spacecraft's movement.

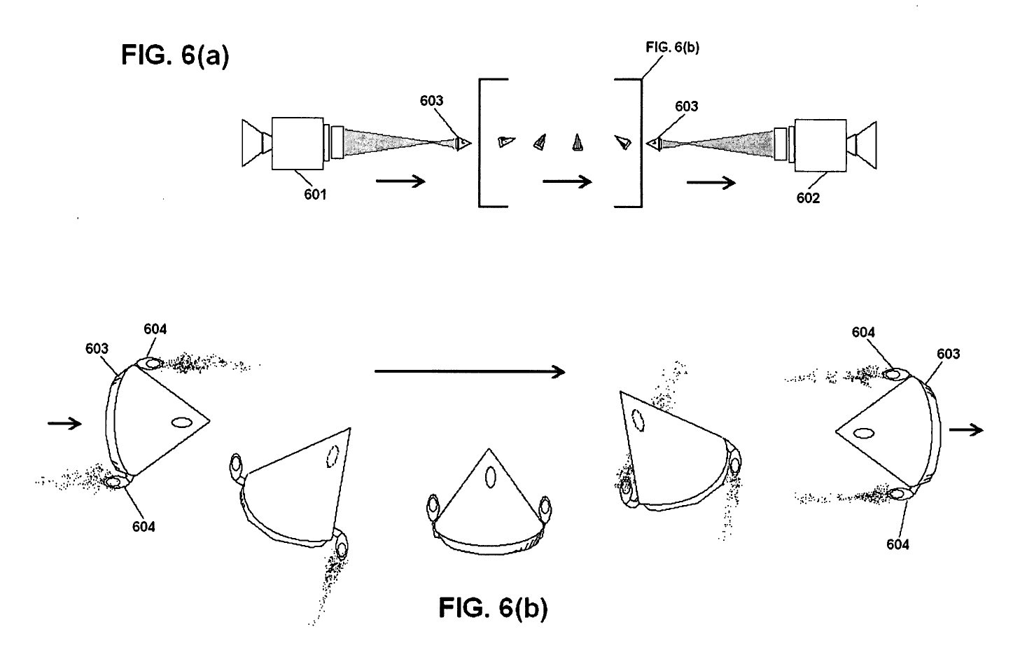

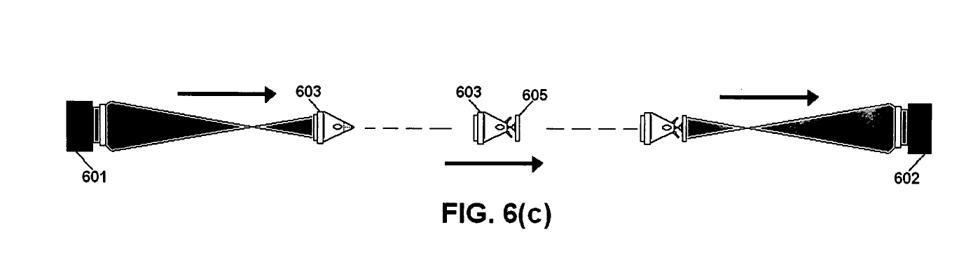

FIG. 6(a) and FIG. 6(b) illustrate a transit configuration which consists of two platforms and a vessel equipped with the necessary modifications for launching from an initial site and docking at a remote destination, in accordance with an exemplary embodiment of the present invention.

Transit configuration 600 consists of first platform 601 and second platform 602. By retrofitting vessel 603 with conventional thrusters and a mirror device in accordance with the present invention, vessel 603 may travel to a desired destination, where second platform 602 has previously been erected to dock with vessel 603. Upon its arrival and docking at second platform 602, vessel 603 may be re-launched and returned to its point of origin at first platform 601.

FIG. 6(b) illustrates a close up of view of an exemplary vessel utilizing conventional thrusters to disengage from a first platform and engage contact with an intracavity laser beam generated from a second platform, in accordance with practice of the present invention.

Once a desired point along a mission path is reached, first platform 601 may disengage its intracavity laser output. Using known methods and predetermined calculations, vessel 603 may then be maneuvered with the aid of conventional thrusters 604 into a proper position at which point second platform 602 may engage its intracavity laser and make contact with vessel 603.

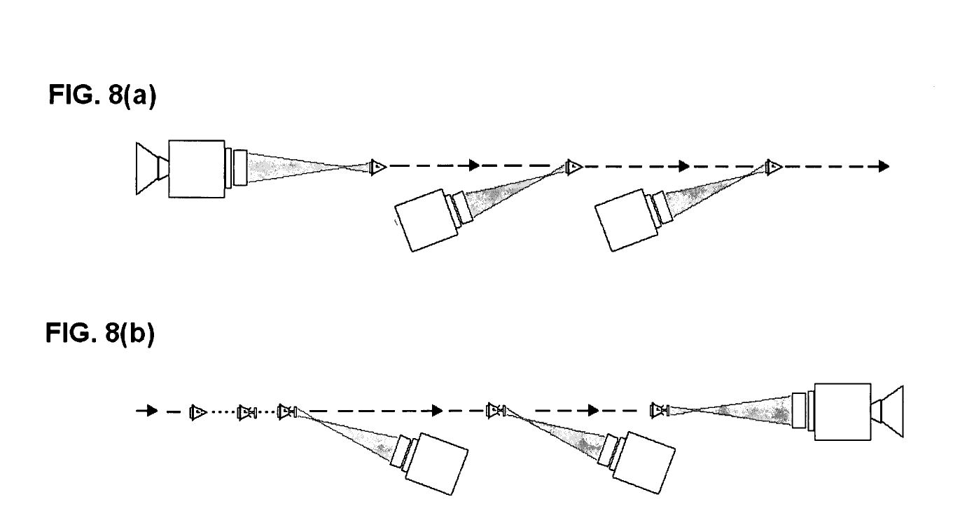

Alternatively, FIG. 6(c) illustrates a transit configuration which comprises of platforms 601 and 602 and a vessel, in accordance with another embodiment of the present invention, wherein such vessel 606 deploys mirror 605 upon reaching a desired destination in order to dock with platform 602. Platform 602 then is able to slow down vessel 603 in order to dock or re-launch vessel 603 back to its original point of origin—in no particularly different fashion than referenced in FIG. 6(a) and (b) above, except this configuration may me more desirable in that less energy would be required to operate vessel 606 since thruster calibration, and use thereof, in order to rotate a vessel, will not be necessary. Furthermore, having multiple mirrors in a vessel may be useful for accelerating or decelerating vessel 606, for example, in a multi-photonic platform configuration flight as discussed later below (see FIG. 8)

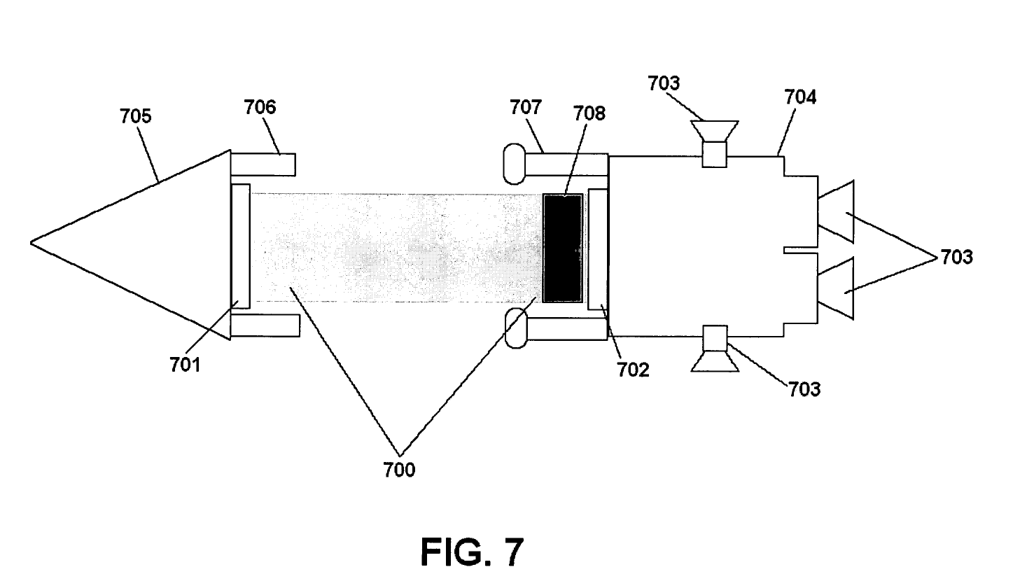

FIG. 7 illustrates a docking configuration utilizing an amplified photonic beam, in accordance with one embodiment of the present invention. Docking configuration 700 comprises of platform 704, which is equipped with typical docking components 707, mirror 702, gain medium 708, conventional thrusters 703, and some pump source (not shown) to generate intracavity beam 709. Docking configuration 700 further comprises of a vessel 705 connected to a mirror 701. In addition to mirror 701, vessel 705 comprises of complementary docking components to allow vessel 705 to properly harbor upon arrival and contact with platform 704.

In one embodiment, platform 704 must be sent at some previous point in time before the launch of vessel 705. This may be done in a few ways including sending a first vessel equipped with components to build or deploy platform 704. In another embodiment, vessel 705 is equipped with the necessary components to deploy platform 704 upon arrival at a particular destination, for example a point of interest in outer space, Earth's orbit, the moon, another planet, a moon of another planet, or an asteroid.

Once deployed and ready for operation, docking configuration 700 is ideal for delivery of supplies, more efficient exploration, and quicker transport from a first platform to platform 704 and back. In some cases, docking configuration 700 may comprise of multiple platforms to accommodate multiple dockings and launchings.

Turning next to FIG. 8(a) and FIG. 8(b), these diagrams illustrate a method of accelerating and decelerating a vessel, respectively, by utilizing a series of photonic laser propulsion platforms configured to progressively project photonic lasers for propelling a vessel into higher speeds or slowing it down from higher velocities. This may be desirable for a number of reasons, including efficiency and economic viability—it may be less expensive for example, to deploy many smaller platforms along a flight or trajectory path than to deploy a single very powerful platform in order to propel the same vessel. Furthermore, utilizing the same technology to decelerate such a vessel is also desirable in applications where deceleration would consist of utilizing large amounts of propellant that otherwise may need to be carried by such vessel, thus keeping its payload fraction low.

These configurations allow for more efficient travel and may make it possible to send a platform, for example a spacecraft, to locations farther than ever before thought possible, at a fraction of the time.

In the near future, with the use of rapidly evolving laser technologies, including but not limited to, Diode Pumped Solid State (DPSS) Laser technologies, solid state laser technologies, or chemical laser technologies, photonic laser propulsion engines will become more compact, lighter, and more energy efficient—features which will make photonic laser propulsion ideal for space borne applications.

One exemplary application of the present invention is in formation flying and fractionated architecture of a platform in combination with other existing conventional thrusters including, but not limited to, cold gas thrusters, warm gas thrusters, electro thermal thrusters, Hall thrusters, pulsed plasma thrusters, laser ablation thrusters, and microwave electric thrusters.

Another exemplary application of photonic laser propulsion is in a nano-meter accuracy formation flight method with photon thrusters and tethers such as Photon Tether Formation Flights (PTFF), with maximum baseline distances over 10 km for next generation space applications. For example, PTFF may utilize photonic laser propulsion to stabilize a group of satellites by using photonic laser propulsion thrusters and tethers, creating contamination-free and highly power efficiency which provides ample mass savings. In addition, PTFF is predicted to be able to provide an unprecedented angular scanning accuracy of 0.1 micro-arcsec, and the retargeting slewing accuracy better than 1 micro-arcsec for a 1 km baseline formation.

A laser-based propulsion engine having an active intracavity thrust amplification system has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A photonic laser propulsion system comprising:
a first platform adapted to generate an intracavity laser; and
a second platform adapted to use said intracavity laser for propulsion.

2. The system of claim 1, further comprising a laser pump source adapted to energize a laser energy for said intracavity laser.

3. The system of claim 2, further comprising a laser gain medium adapted to amplify said intracavity laser.

4. The system of claim 2, wherein said first platform further comprises a first mirror adapted to focus said laser energy.

5. The system of claim 4, wherein said second platform further comprises a second mirror adapted to receive said laser energy to form said intracavity laser.

6. The system of claim 5, wherein said second platform further comprises a lens adapted to focus an extracavity laser energy leaked from said intracavity laser.

7. The system of claim 6, wherein said second platform further comprises a device for converting said extracavity laser energy into an electrical power source.

8. The system of claim 2, further comprising a thermal management system for thermal regulation of said intracavity laser.

9. The system of claim 3, further comprising an optical cavity resonator configured to amplify said intracavity laser, wherein said optical cavity resonator is selected from a group consisting of confocal resonators, parabolic resonators, and hemispherical resonators.

10. The system of claim 2, wherein said laser gain medium comprises a solid state laser crystal selected from a group consisting of Nd:YAG, Er:YAG, Nd:YLF, Nd:YCa₄O, Nd:Glass, Ti:sapphire, Tm:YAG, Yb:YAG, Ho:YAG, Ce:LiCAF, U:CaF₂, Sm:CaF₂, and Nd:YVO₄.

11. The system of claim 5, further comprising a device configured to calibrate the curvature and position of said first mirror and said second mirror to compensate for movement and atmospheric disturbance.

12. A platform configured to generate an intracavity laser for photonic laser propulsion, comprising:
a laser pump adapted to energize a laser energy for an intracavity laser; and
a first mirror, coupled to said laser pump and positioned to form an optical cavity adapted for focusing said laser energy,
wherein said optical cavity is configured for amplifying said intracavity laser to generate a thrust, and
wherein said thrust is used for propulsion.

13. The platform of claim 12, wherein said optical cavity comprises a second mirror positioned at a remote location to reflect said laser energy onto said first mirror and amplify said intracavity laser.

14. The platform of claim 12, further comprising a laser gain medium adapted to amplify said intracavity laser.

15. The platform of claim 13, wherein said optical cavity further comprises a device configured to calibrate the curvature of said first mirror and said second mirror to compensate for movement and atmospheric disturbance.

16. The platform of claim 14, further comprising a thermal management system for thermal regulation of said gain medium.

17. The platform or claim 14, wherein said gain medium is a solid state laser crystal selected from the group consisting of of Nd:YAG, Er:YAG, Nd:YLF, Nd:YCa₄O, Nd:Glass, Ti:sapphire, Tm:YAG, Yb:YAG, Ho:YAG, Ce:LiCAF, U:CaF₂, Sm:CaF₂, and Nd:YVO₄.

18. A platform configured to use an intracavity laser for photonic laser propulsion, comprising a first mirror positioned to receive a laser energy generated from a remote location,
wherein said first mirror is adapted to form an optical cavity,
wherein said optical cavity is configured for amplifying an intracavity laser to generate a thrust, and
wherein said thrust is used for propulsion.

19. The platform of claim 18, wherein said optical cavity comprises a second mirror positioned at a remote location to project said laser energy onto said first mirror and amplify said intracavity laser.

20. The platform of claim 18, further comprising a lens coupled to said first mirror, said lens adapted to focus an extracavity laser energy leaked from said intracavity laser.

21. The platform of claim 20, further comprising a device for converting said extracavity laser energy into an electrical power source.

22. The platform of claim 21, wherein said electrical power source is used to power operating systems that control said platform.

23. The platform of claim 18, wherein said optical cavity further comprises a device configured to calibrate the curvature of said first mirror and said second mirror to compensate for movement and atmospheric disturbance.

24. A multiple platform system for photonic laser propulsion comprising:
a vessel adapted to receive an intracavity laser; and
a plurality of platforms adapted to generate said intracavity laser to propel said vessel, wherein each of said plurality of platforms further comprise:
a first mirror,
a laser gain medium adapted to amplify said intracavity laser, and
a laser pump source adapted to energize a laser energy for said intracavity laser,
wherein said laser energy is projected onto a second mirror attached to said vessel, and
wherein said vessel uses the thrust generated from said intracavity laser for acceleration and deceleration of said vessel.

25. A photonic laser propulsion system comprising:
a first platform;
a second platform, positioned opposite said first platform;
a laser pumping system attached to said first platform, wherein said laser pumping system is adapted to generate a laser energy;
a first mirror, attached to said first platform, comprising a back side adapted to transmit said laser energy to form an intracavity laser, and a front side adapted to reflect said intracavity laser;
a second mirror, attached to said second platform, comprising a front side adapted to reflect said intracavity laser, wherein said intracavity laser beam reflects a plurality of times between said front side of said first mirror and said front side of said second mirror to generate a thrust force,
wherein said laser pumping system further comprises:
a laser gain medium attached to a back of, in front of or around said first mirror on said first platform, positioned so that said laser energy generated by said laser pumping system energizes said gain medium to amplify said intracavity laser beam reflecting between said first mirror and said second mirror, said laser gain medium comprising a solid state laser crystal, wherein said solid state laser crystal is selected from a group consisting of Nd:YAG, Er:YAG, Nd:YLF, Nd:YCa₄O, Nd:Glass, Ti:sapphire, Tm:YAG, Yb:YAG, Ho:YAG, Ce:LiCAF, U:CaF₂, Sm:CaF₂, and Nd:YVO₄,
a thermal management system for thermal regulation of said first mirror, said second mirror, and said gain medium, and
a laser diode for generating said laser energy; and
wherein said second platform further comprises:
a laser power meter;
a lens positioned between a back of said second mirror and said laser power meter,
wherein a percentage of said intracavity laser beam transmits through said second mirror to form an extracavity laser beam, and
wherein said extracavity laser beam is focused towards a receiving input area of said laser power meter; and
a plurality of photovoltaic cells configured to convert a laser beam power generated from said extracavity laser beam into an onboard electrical power source for powering electronics and conventional propulsion thrusters.
